(19) United States
(12) Patent Application Publication
(10) Pub. No.: US 2021/0081546 A1
(43) Pub. Date: Mar. 18, 2021

(54) SYSTEM AND METHOD FOR THE CRYPTOGRAPHICALLY PROTECTED MONITORING OF AT LEAST ONE COMPONENT OF A DEVICE OR AN APPARATUS

(71) Applicant: Siemens Aktiengesellschaft, München (DE)

(72) Inventor: Rainer Falk, Poing (DE)

(21) Appl. No.: 16/642,287

(22) PCT Filed: Jun. 7, 2018
(86) PCT No.: PCT/EP2018/065011

§ 371 Date: Feb. 26, 2020

(30) Foreign Application Priority Data
Aug. 31, 2017 (EP) 17188718.5

(51) Int. Cl. G06F 21/60; H04L 9/32; G06F 11/34; G06F 16/23

(52) U.S. Cl. CPC G06F 21/602; H04L 9/3239; H04L 2209/38; G06F 11/3476; G06F 16/2379; G06F 11/3495

(57) ABSTRACT

Provided is a system for the cryptographically protected monitoring of at least one component of a device or a system, including a component for providing at least one second element of a blockchain, having at least one transaction dataset including a monitored operating state of at least one component of the device or the system; a device for linking the at least one second element to a first element of the same or of a further blockchain; a device for providing a checking function which checks a transaction which is defined by the at least one transaction dataset and which is to be carried out for integrity; and a device for forming a transaction dataset having an action associated with the operating state, depending on the checking result delivered by the checking function, wherein the transaction defined by the transaction dataset can be carried out by a system component.

### CROSS-REFERENCE TO RELATED APPLICATIONS

This application claims priority to PCT Application No. PCT/EP2018/065011, having a filing date of Jun. 7, 2018, which is based off of EP Application No. 17188718.5, having a filing date of Aug. 31, 2017, the entire contents both of which are hereby incorporated by reference.

### FIELD OF TECHNOLOGY

The following relates to a system and a method for the cryptographically protected monitoring of at least one component of a device or an apparatus, and to an associated computer program (product).

### BACKGROUND

Hardware and software components of a device or apparatus can have a malfunction or be intentionally manipulated. Critical functions should be implemented reliably in this case.

The security of the Internet of Things and (field) devices or else embedded systems or devices which can be used in an industrial apparatus, and the prevention of intentional attacks are becoming increasingly important. A successful manipulation can result in a malfunction in control functions of the abovementioned devices (device components). Therefore, there is also a need to protect the integrity of control functions in particular for autonomous or assisted driving and for cloud-based robot control (cloud robotics) within the sphere of Industry 4.0.

Goals such as integrity, confidentiality or authenticity of the data transfer of objects can be achieved by means of cryptographic protection functions. Intentional, targeted attacks on the data transfer are thereby repulsed.

The term “security” essentially relates to the security, confidentiality and/or integrity of data and the transfer thereof and also security, confidentiality and/or integrity during access to corresponding data. Authenticity during data transfers or during data access is also encompassed, inter alia, by the term “security”. A cryptographic functionality is generally understood to mean, for example, a function for encryption, for protecting confidentiality, for protecting integrity and/or for authenticating data (e.g. user data, control data, configuration data or administrative data) and/or authenticating users or objects. In this case, the cryptographic protection functionality can comprise, for example, one or more of the functionalities presented below:
key storage
system and/or user authentication
certification
encryption
decryption
calculation of a cryptographic checksum (e.g. message authentication code or digital signature)
checking of a cryptographic checksum (e.g. message authentication code or digital signature)
key agreement
key generation
generation of random numbers (e.g. seed generation)
licensing
support of systematic monitoring functions (e.g. tamper protection, system integrity, security incident and event management SIEM)
monitoring of data
validation of data
filtering of data

The cryptographic functionalities enumerated can be implemented here in each case once again with other/further methods or combinations of these methods.

In order to monitor malfunctions of system or device components, it is possible to use so-called watchdogs https://de.wikipedia.org/wiki/Watchdog. It is thus possible e.g. to identify infinite loops in software and, if appropriate, to restart a device automatically. However, watchdogs are suitable rather for identifying random errors, but not for identifying a targeted manipulation (security).

It is therefore a goal to improve the integrity of systems (e.g. field devices, control devices, industrial PC, server, virtual machine, software container) as an essential protection goal. The intention is to prevent or at least identify an inadmissible alteration (manipulation) of such a possibly software-based system.

### SUMMARY

An aspect relates to provide a method and a system or device or arrangement which offer such an improvement.

Embodiments of the invention include a system (or device/arrangement) for the cryptographically protected monitoring of at least one component of a device or an apparatus comprising:
means or a component or a device for providing at least one second link (BCNF) of a blockchain, said at least one second link comprising at least one transaction data set comprising a monitored operating state of at least one component of the device or the apparatus.
means or device for linking the at least one second link to a first link of the same or a further blockchain.
means or device for providing a cryptographically configured checking function which checks a transaction to be carried out, which transaction is defined by the at least one transaction data set, for integrity or admissibility or validity, and
means or device for forming a transaction data set having a measure assigned to the operating state, depending on the checking result yielded by the checking function, wherein the transaction defined by the transaction data set is able to be carried out by a component of the device or of the apparatus and the measure is able to be initiated and/or able to be carried out by the same or a different component or by a station situated outside the device or the apparatus.

The station situated outside can be a control system or a (control) computer for the components or the apparatus. The formation of the transaction data set with regard to the measure can be a different transaction data set than that mentioned above (relating to operating state) or can be integrated into the transaction data set mentioned above as part thereof. The measure can be embodied as program code or simply be a signal for forwarding the latter to said components or said station. The measure can be embodied as a monitoring confirmation transaction (e.g. OK, error, absence of the operating state monitoring information, or manipulation) which matches or is assigned to or results or is derived from the operating state that is monitored with the aid of the transaction data set mentioned above. In particular, by means of a monitoring confirmation transaction, a measure (protective measure) can be triggered automatically in the event of an identified manipulation of a device or an apparatus. The measure can prevent a manipulation from resulting in damage to the device or the apparatus or the environment thereof. This takes place with high reliability since the operating state monitoring and the formation of the monitoring confirmation transaction are effected in a manner protected cryptographically by a blockchain.

The technology of blockchains (or block chains) or “distributed ledgers” is currently a technology that is being intensively discussed.

A blockchain is generally understood to mean a database whose integrity (protection against subsequent manipulation) is safeguarded by storage of the one-way function value, also called hash value, of the preceding data set or block or link in the one respectively succeeding the latter, that is to say by cryptographic linking. The protection arises as a result of a majority of trustworthy nodes in a blockchain network that carry out so-called mining or validation of blocks. In the network of the nodes participating in a blockchain, at regular intervals, for example every 10 minutes, a new block is formed and the hash value of an existing block is concomitantly stored in the process. Once transactions appear in the chain, they are no longer able to be altered without being noticed. The validity of transactions to be stored in the block is checked during this mining process. Besides a mining process as “proof of work”, alternatives are also known, in particular a “proof of stake”, in which a block is confirmed by a blockchain node selected pseudo-randomly, but deterministically, or an access-controlled blockchain (permissioned blockchain).

Known blockchain systems are Bitcoin and Ethereum. While Bitcoin was originally created for cryptocurrency transfers, Ethereum is based on the incorporation of so-called smart contracts. The conditions agreed in a smart contract are safeguarded by the blockchain and the contract itself is handled via the network. The implementation of the contract conditions is monitored by way of associated transactions carried out: follow-up actions provided in a programmed smart contract can be carried out depending on the transaction effected. Further blockchain realizations, e.g. Hyperledger, are possible.

A transaction data set that is protected in the blockchain generally comprises program code. The term “smart contract” is understood to mean a program code in which conditions can be defined at the time of creation and can be evaluated at its time of execution, such that specific transactions of a specific amount (of money) to one specific recipient or a plurality of specific recipients may or may not be carried out.

The transaction can be carried out with the aid of the transaction data set. A transaction is understood to mean a reciprocal transfer of virtual or real goods or a payment or other information from a sender to a recipient. A relatively simple stack-based runtime environment is used in the case of Bitcoin. In this case, a transaction comprises the checksum for checking the validity or integrity of the transaction. The blockchain platform Ethereum supports a freely programmable runtime environment, such that the program code of a blockchain can be realized flexibly. In this case, e.g. a business logic is stored as program code in the transaction data set and thus in the blockchain. From this viewpoint, the transaction to be carried out is stored in a (chain) link of the blockchain. Accordingly, a differentiation between the transaction to be carried out and the transaction data set configured for carrying out the transaction is hardly possible in this context. The blockchain platform Hyperledger also supports a freely programmable runtime environment for implementing smart contracts.

The checking function can be integrated in the first link in the blockchain, in particular in the first transaction data set. However, the checking function can also be arranged outside a blockchain in a runtime environment for carrying out the transaction. Said checking function generally carries out an integrity check. In information security, integrity has the meaning of correctness, completeness and unmanipulated data. Depending on this, an operating state of a device or apparatus component may be admissible or valid. The checking function can be implemented by a so-called smart contract of a blockchain.

In order to realize a kind of cryptographically protected monitoring function e.g. in the form of a watchdog, the operating state of at least one component (e.g. NW) of the device (IoT) or of the apparatus is represented in at least one transaction data set. Embodiments of the invention thus provides, a blockchain-based cryptographic monitoring function, in particular a watchdog (for devices, containers, virtual machines (VM)).

Blockchains can generally only exchange data within their own infrastructure. So-called oracles can establish a connection to the “outside world”. So-called integrity oracles of a device put integrity measurement data of the device into a blockchain. That is to say that transactions are formed and included in a blockchain transaction data structure, which transactions comprise integrity measurement data which may include the following information or data as follows:
Device integrity information of a VM, of a (software) container (docker), of an embedded device, of a server, which can relate to loaded firmware and loaded programs (e.g. version information, hash value), process lists, checksums of memory contents, configuration data.
Sensor measurement data, actuator driving data (i.e. data of an input/output interface).
Data introspection of a virtual machine or of a container (memory introspection, processes within the virtual machine/containers, hash values of the program code data of the processes carried out).

One advantage of embodiments of the invention is that the integrity of the implementation is protected by the blockchain-based implementation not only vis-á-vis random errors, but also against targeted manipulation. Furthermore, the blockchain platform can be implemented on various hardware platforms, with the result that utilization of a hardware trojan horse of a hardware platform is prevented or at least made more difficult. Likewise, the blockchain platform can be implemented on various software platforms, e.g. various firmware and various operating systems, with the result that utilization of an undocumented function (backdoor) of a firmware/software platform is prevented or at least made more difficult. In particular, an attempted utilization of a hardware trojan horse or of an undocumented function can be reliably identified.

One development of embodiments of the invention provides for the first link to comprise a further monitored operating state of at least one further component of the device or of the apparatus.

One development of embodiments of the invention provides for a negative checking result to comprise a value for an error and/or for a manipulation or for an absence of an expected transaction data set.

One development of embodiments of the invention provides for a positive checking result to comprise a value for a confirmation (e.g. “runtime integrity tested” or “safe for use”).

One development of embodiments of the invention provides for the monitoring of the at least one and/or further component to be implemented by means of a so-called smart contract.

One development of embodiments of the invention provides for the operating state to relate to a device- or apparatus-internal state.

One development of embodiments of the invention provides for the operating state to relate to a state of sensors, actuators and/or control units for the device or the apparatus which are arranged outside the device or the apparatus.

A further aspect of embodiments of the invention is a method for the cryptographically protected monitoring of at least one component of a device or an apparatus comprising the following steps:
providing at least one second link of blockchain, said at least one second link comprising at least one transaction data set, wherein a monitored operating state of at least one component of the device or of the apparatus is represented in the transaction data set,
linking the at least one second link to a first link of the same or a further blockchain,
providing a cryptographically configured checking function which checks the transaction data set for integrity/admissibility, and
forming a transaction data set having a measure assigned to the operating state, depending on the checking result yielded by the checking function, wherein the transaction defined by the transaction data set is carried out by a component of the device or of the apparatus and the measure is initiated and/or is carried out by the same or a different component or by a station situated outside the device or the apparatus.

The method is repeatable. A plurality of links beginning with a start link can be provided or formed or generated, wherein each link by itself can contain a checking function of the type mentioned above or correspondingly subfunctions thereof. That is to say that the blockchain has a sequence of transactions that each monitor an operating state of a (device or apparatus) component. As a result, the operation of a device or of an apparatus can be monitored continuously.

The method can be developed in accordance with the developments and environments of the system or arrangement mentioned above.

The method is carried out in a computer-aided manner. Unless indicated otherwise in the following description, the terms “carry out”, “calculate”, “computer-aided”, “compute”, “ascertain”, “generate”, “configure”, “reconstruct” and the like relate to actions and/or processes and/or processing steps which change and/or generate data and/or convert the data into other data, wherein the data can be represented or be present in particular as physical variables, for example as electrical pulses. In particular, the expression “computer” should be interpreted as broadly as possible to cover in particular all electronic devices having data processing properties. Computers can thus be for example personal computers, servers, programmable logic controllers (PLCs), handheld computer systems, pocket PC devices, mobile radio devices and other communication devices which can process data in a computer-aided manner, processors and other electronic devices for data processing.

In association with embodiments of the invention, “computer-aided” can be understood to mean for example an implementation of the method in which in particular a processor performs at least one method step of the method.

In association with embodiments of the invention, a processor can be understood to mean for example a machine or an electronic circuit. A processor can be in particular a central processing unit (CPU), a microprocessor or a microcontroller, for example an application-specific integrated circuit or a digital signal processor, possibly in combination with a storage unit for storing program instructions, etc. A processor can for example also be an IC (integrated circuit), in particular an FPGA (field programmable gate array) or an ASIC (application-specific integrated circuit), or a DSP (digital signal processor) or a graphic processing unit (GPU). Moreover, a processor can be understood to mean a virtualized processor, a virtual machine or a soft CPU. It can for example also be a programmable processor which is equipped with configuration steps for performing the stated method according to embodiments of the invention or is configured with configuration steps in such a way that the programmable processor implements the features according to embodiments of the invention of the method, of the component, of the modules, of the means, or of other aspects and/or partial aspects of embodiments of the invention.

In association with embodiments of the invention, a “storage unit” can be understood to mean for example a memory in the form of main memory (random-access memory, RAM) or a hard disk.

The means mentioned above can form a blockchain node functionality. In association with embodiments of the invention, moreover, means can be understood to be for example a processor and/or a storage unit for storing program instructions. By way of example, the processor is specifically designed to execute the program instructions in such a way that the processor executes functions for implementing or realizing the method according to embodiments of the invention or a step of the method according to embodiments of the invention.

In association with embodiments of the invention, “providing” can be understood to mean for example creating, loading or storing of the transaction data set on or by a data carrier or platform.

Furthermore, provision is made of a computer program product (non-transitory computer readable storage medium having instructions, which when executed by a processor, perform actions) having program instructions for the system of the type described above, which is configured by means of the program instructions which are suitable for the cryptographically protected monitoring of at least one component of a device or an apparatus and form at least one link of a blockchain, the transaction data set of said at least one link comprising a monitored operating state of at least one component of the device or of the apparatus.

The computer program (product) can form a runtime environment of the type mentioned above.

Additionally disclosed is a variant of the computer program product having program instructions for the configuration of a creating device, for example a 3D printer, a computer system or a production machine suitable for creating processors and/or devices.

The uses, devices and computer program (products) can be embodied in accordance with the developments/embodiments of the abovementioned method and the developments/embodiments thereof.

Furthermore, a providing device for storing and/or providing the computer program product is possible. The providing device is a data carrier, for example, which stores and/or provides the computer program product. Alternatively and/or additionally, the providing device is for example a network service, a computer system, a server system, in particular a distributed computer system, a cloud-based computer system and/or virtual computer system which stores and/or provides the computer program product in the form of a data stream.

This providing is effected for example as a download in the form of a program data block and/or instruction data block, as a file, in particular as a download file, or as a data stream, in particular as a download data stream, of the complete computer program product. However, this providing can for example also be effected as a partial download which consists of a plurality of parts and in particular is downloaded via a peer-to-peer network or is provided as a data stream. Such a computer program product is read into a system for example using the providing device in the form of a data carrier and executes the program instructions, such that the method according to embodiments of the invention is carried out on a computer or the creating device is configured in such a way that it creates said device according to embodiments of the invention and/or the link and/or the blockchain.

### BRIEF DESCRIPTION

Some of the embodiments will be described in detail, with reference to the following figures, wherein like designations denote like members, wherein:

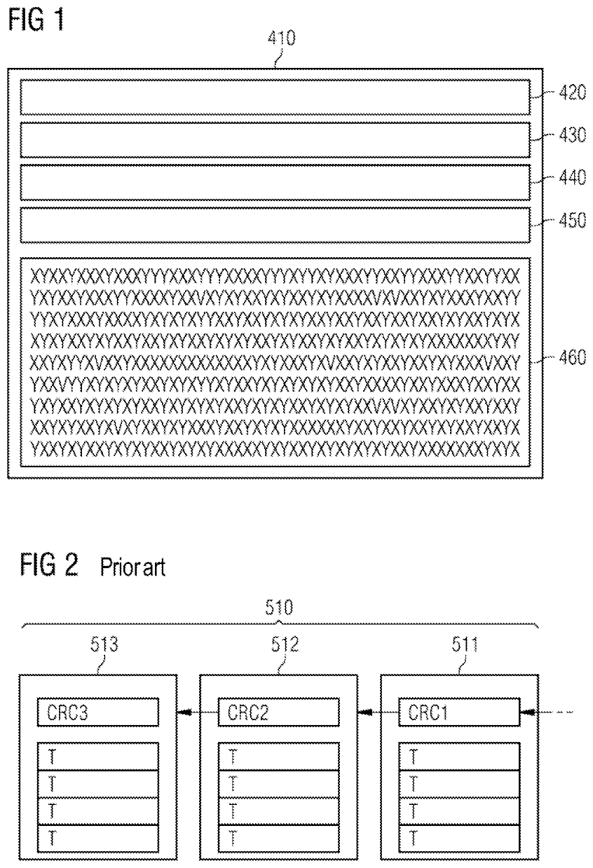

FIG. 1 shows one exemplary embodiment of a transaction data set of a link of a blockchain:

FIG. 2 shows one exemplars embodiment of a blockchain;

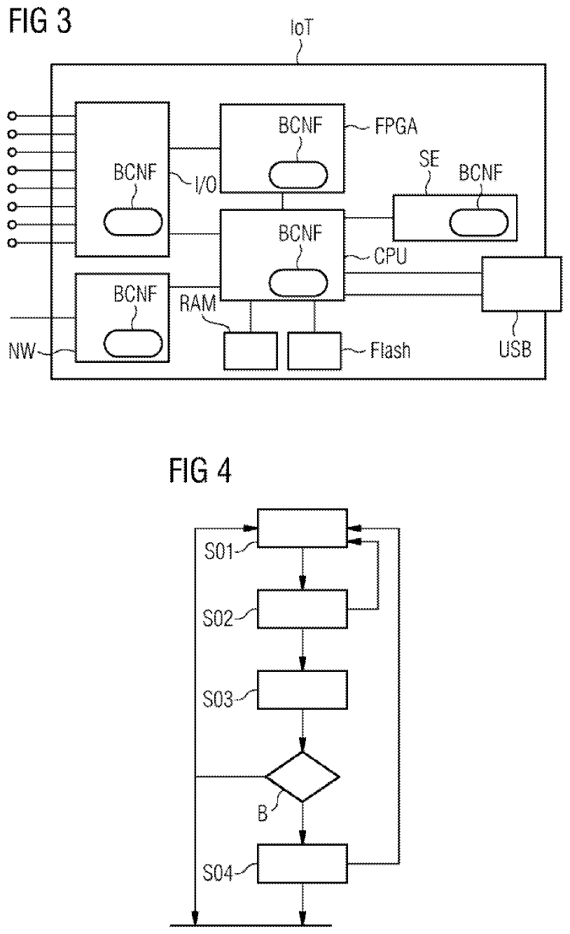

FIG. 3 shows one exemplars embodiment of the invention as to how a blockchain functionality can be integrated into a system or device; and

FIG. 4 schematically shows a flow diagram of the method according to embodiments of the invention.

In the figures, functionally identical elements are provided with the same reference signs, unless indicated otherwise.

### DETAILED DESCRIPTION

In specific detail, FIG. 2 shows the links, for example a first link 511, a second link 512 and a third link 513, of a blockchain 510.

Such a blockchain is known for example from https://de.bitcoin.it/wiki/Blockette.

The links each comprise a plurality of transactions T. The links each additionally also comprise a cryptographic hash value CRC1, CRC2, CRC3, which is formed depending on the predecessor link. Consequently, the first link 511 comprises a first hash value CRC1 from its predecessor link, the second link 512 comprises a hash value CRC2 from the first link 511, and the third link 513 comprises a hash value CRC3 from the second link 512. The hash value can be in particular a cryptographic hash value, which is determinable e.g. by means of SHA2-256, SHA2-384, SHA-3, BLAKE2.

FIG. 1 shows one exemplary embodiment of a transaction data set.

A transaction T can be carried out with the aid of the transaction data set 410. The links 513, 512, 511 can each comprise for their transactions T a hash (function) value formed depending on the transaction data sets 410. A hash tree, e.g. a Merkle tree or Patricia tree, is usually used, the root hash value of which is stored in a block or link.

A block or link can furthermore have a time stamp, a digital signature, a proof-of-work verification. In this context, “proof-of-work verification” can be understood to mean for example solving a computationally intensive task which is to be solved in particular depending on the link content/content of a transaction data set. Such a computationally intensive task is for example also referred to as a cryptographic puzzle.

In this case, the program code 460 is e.g. a smart contract. The transaction data set 410 can comprise even further data such as, for example, a subject 420 (e.g. Siemens SiemensABC), a public key 430 (e.g. 3A76E21876EFA03787FD629A65E9E990 . . . ), the used algorithm 440 of the public key 430 (e.g. ECC) and a parameter indication 450 concerning the algorithm (e.g. Curve: brainpoolP160rl).

The transaction data set 410 includes a hash value (e.g. SHA256) for the smart contract 460. The smart contract can thus no longer be altered subsequently without being noticed.

FIG. 3 shows one embodiment of how a blockchain functionality can be integrated into a system or into a device.

Such devices can be for example vehicles, driverless transport systems, robots, test devices or other components of an industrial apparatus.

FIG. 3 shows a device IoT, in particular a field device, comprising a processing unit CPU, a programmable digital circuit FPGA, CPLD, a secure element SE and a plurality of input/output interfaces I/O for connecting sensors and actuators, a network interface NW, and a USB interface USB. Memory assemblies RAM and Flash are additionally present.

The secure element can have safety-relevant measures for a control function, such as e.g. stopping a vehicle or robot before a collision occurs. The safety or protective measures for a control function are ensured by a watchdog. Safety-critical “malfunctions” can thus be prevented in a safeguarded and manipulation-protected manner.

According to embodiments of the invention, the components of the field device contain a blockchain node functionality BCNF. That is to say that the nodes, in the example the components, jointly realize a (device) blockchain 510. They can adjust transactions T, check transactions, and form links 513, 512, 511 or blocks with checked transactions.

The transactions T relate to e.g. a device self-test or component self-test of a component of the device, a change of operating mode (e.g. maintenance, regulation operation, error mode, restricted emergency operation mode), a device integrity self-test, security watchdog (e.g. integrity test of firmware data, of configuration data, check of ongoing processes or tasks), monitoring of device sensors (temperature, voltage supply, housing switches, tamper sensors).

A smart contract of the blockchain analyzes data and can issue a watchdog confirmation transaction (e.g. OK, failure, manipulation or absence of an expected transaction). The device IoT itself, a further device (e.g. safety control computer) and/or a control station can evaluate the blockchain information, e.g. a confirmation transaction or error transaction (alarm, reboot, emergency stop, deactivation of output interfaces, blocking of network interfaces). The blockchain can be realized locally within the device. The device IoT can in this case be a control device, a field device, an IoT device. A device can also have a server functionality, e.g. an edge cloud server functionality or an IoT gateway with downloadable Apps. A hypervisor or a container runtime can be implemented on such devices in order to execute a plurality of executables (executable programs such as Apps, containers) on said devices.

In particular, the blockchain can be realized on a plurality of processors or process cores or on a plurality of virtual machines/containers of a device. In the context according to embodiments of the invention, a blockchain is not used to realize a distributed transaction database in accordance with the prior art mentioned, rather the blockchain is realized by a plurality of components within a device. The blockchain for realizing the integrity watchdog can be realized on one device or in a manner distributed among a plurality of devices or components thereof. As a result, a plurality of devices can reciprocally monitor the integrity. Furthermore, system integrity information can be determined and tested, in the case of which the device integrity information of a plurality of devices is checked jointly. In particular, it is possible to check the integrity information of a plurality of structurally identical devices for correspondence. Such a realization is advantageous e.g. for IoT devices.

The realization of a device-internal blockchain also has the advantage that on the device functions such as a self-test function, a device integrity self-test, a security watchdog can be realized with high reliability on the device. Since there is not solely a single component that monitors the device, a manipulation by a hacker is made more difficult. The individual components of a device can reciprocally monitor themselves in a manipulation-protective manner or jointly realize device integrity monitoring in a distributed manner with the aid of the blockchain functionality. A device-internal blockchain can be formed anew upon the device being started. That is to say that, upon the device being started (reboot), a genesis block or link is formed as a start link of the device blockchain. The genesis block is stored on the components of the device which realize the device blockchain. In a further embodiment, the genesis block of the device blockchain is set up when a device configuration is set up or changed. In a further embodiment, the genesis block of the device blockchain is set up in the event of the sealing of a device configuration. Sealing means that after a sealing process has taken place, a device configuration can no longer be modified, but rather only still erased. In a further embodiment, the genesis block of the device blockchain is formed during the production of the device and is introduced into the device. The genesis block of the device blockchain is stored on the components of the device which realize the device blockchain. A device-specific genesis block is in each case set up on a plurality of specimens of a device.

Furthermore, it is possible to keep available only a specific number of links of the device-internal blockchain on the device. That is to say that when a new block of the blockchain is formed, the earliest block is erased. This is advantageous in order to limit the memory space of the blockchain. This is expedient particularly in the case of control devices and IoT devices having limited memory space. This can also be understood to mean that the genesis block is dynamic, that is to say that a blockchain link e.g. 10 000 blocks earlier is used as the genesis block. It is possible here for the plurality of blockchain nodes of the device each to use the same block as a dynamic genesis block. To that end, a deterministic method can be used by the plurality of components (e.g. 10 000 blocks ago), such that the component determines the same block as a common dynamic genesis block. In a further embodiment, a common dynamic genesis block can be determined by the blockchain nodes by means of blockchain transactions. To that end, e.g. each node can cast a vote with an index, and the block with the smallest index (i.e. at the earliest node) is used as a new common dynamic genesis block. However, it is also possible for each device-internal blockchain node itself to determine a component-specific dynamic genesis block.

A device within the meaning of embodiments of the invention can be one component or one structural part or a plurality of components situated in a housing. However, a device can also comprise a plurality of components. In this regard, it can comprise e.g. expansion modules which e.g. can be plugged on or can be plugged into the device (e.g. IO modules for a main assembly). Moreover, the device can consist internally of a plurality of assemblies, e.g. circuit boards, which are connected e.g. via a backplane bus.

In a further embodiment, a cross-device blockchain is realized. In this regard, a device which realizes a device blockchain can check transaction data sets of further devices and include them in the device blockchain in the event of a positive checking result. This has the advantage that a device which supports a device blockchain can check transaction data of further devices, not supporting a device blockchain, and can include them in its device blockchain.

In a further embodiment, the field device contains a plurality of computation cores (physical computation cores or virtual computation cores) which realize a redundant system. To that end, e.g. two separate CPUs can be provided, and it is possible to effect double computation (e.g. with regularly coded data and data coded in a modified manner), two CPU computation cores, two or more virtual machines, two or more containers. In order to detect errors (e.g. transient errors, HW defect), a blockchain-based consistency check is effected (blockchain-based lock-step architecture). To that end, the output data or intermediate processing states of the at least two computation cores at predefinable points in time are checked for consistency or correspondence.

To that end, there is generated for each computation core a transaction comprising the output data or intermediate data of the respective computation cores (directly or as a checksum, e.g. CRC value or cryptographic hash value). By means of the distributed blockchain realization, the transaction data sets of the plurality of computation cores are checked for consistency/correspondence, e.g. by means of a smart contract (program code) of the blockchain.

If no correspondence is present, then the device can be stopped or its IO interfaces can be blocked. To that end, a component can deactivate itself if its blockchain node function detects a device error. It is likewise possible for a component, e.g. the secure element, to provide a control signal if it detects a device error. The control signal can e.g. deactivate the IO interface (e.g. switch the interfaces to be at high impedance, block the network interface) or restart the CPU or the FPGA or hold it in an initial state (reset). The device blockchain here thus realizes a device watchdog. The latter can be realized with high trustworthiness by virtue of the blockchain logic. Monitoring for correspondence or consistency is effected by means of the device blockchain or the safety watchdog realized by means of the device blockchain. A redundant, safety-critical system can thus be realized on conventional hardware and in a manipulation-protected manner.

As already indicated above and illustrated schematically in FIG. 3, the following manifestations of embodiments of the invention are possible:

The integrity of the implementation is protected by the blockchain-based implementation not only vis-á-vis random errors, but also against targeted manipulation.

FIG. 4 shows by way of example a flow diagram of the method according to embodiments of the invention, in which the steps are identified by S01 to S04.

In steps S01 and S02, a first and a second link of a blockchain are formed or provided and are linked together. In this regard, a link comprises one or more transaction data sets for example of the type as already explained above. The transaction data set comprises for example program code suitable for monitoring an operating state of a device, e.g. an IoT device, or of the components thereof or of components of an apparatus. The addressed monitoring function(ality), e.g. integrity watchdog or manipulation watchdog, is thus integrated into the transaction data set. Step S03 involves providing a cryptographic checking function which checks the transaction defined by a transaction data set for integrity or admissibility or validity.

In accordance with the condition B, which is dependent on the checking result, the method is ended in the case of a negative checking result (inadmissibility or invalidity of the transaction) or is continued with step S01. That is to say that a further link is formed with a transaction data set which possibly stands up to the checking as admissible. If the abovementioned checking result (positive) judges the transaction to be admissible or valid, then in S04 a transaction data set is formed which has a measure which matches the operating state or is assigned to the operating state or is derived from the operating state. Said measure can be an error correction, a restart, an emergency stop/emergency off, activation of an emergency operation mode or else just an error or warning indication. The transaction defined by the transaction data set can be carried out by a component of the device or of the apparatus. The measure can be initiated or forwarded and/or carried out by the same or a different component or by a station situated outside the device or the apparatus. The method can subsequently be ended or can subsequently be continued with step S01. The method can thus be repeated. Steps S01 and S02 can be repeated for forming a blockchain until a predefinable number of blockchain links has been reached or no more transactions need be carried out. Depending on the measure, the formation of the transaction data set in accordance with S04 can lead to a confirmation transaction or error transaction already mentioned above.

Although embodiments of the invention have been more specifically illustrated and described in detail by means of the preferred exemplary embodiment, nevertheless embodiments of the invention are not restricted by the examples disclosed and other variations can be derived therefrom by the person skilled in the art, without departing from the scope of protection of embodiments of the invention.

The above-described processes or method sequences can be implemented on the basis of instructions present on computer-readable storage media or in volatile computer memories (referred to hereinafter in combination as computer-readable storage units). Computer-readable storage units are for example volatile memories such as caches, buffers or RAM and also nonvolatile memories such as exchangeable data carriers, hard disks, etc.

In this case, the above-described functions or steps can be present in the form of at least one instruction set in/on a computer-readable storage unit. In this case, the functions or steps are not tied to a specific instruction set or to a specific form of instruction sets or to a specific storage medium or to a specific processor or to specific execution schemes and can be executed by software, firmware, microcode, hardware, processors, integrated circuits etc. in standalone operation or in any desired combination. In this case, a wide variety of processing strategies can be used, for example serial processing by a single processor or multiple processing or multitasking or parallel processing, etc.

The instructions can be stored in local storage units, but it is also possible to store the instructions on a remote system and to access them via a network.

The term “processor”, “central signal processing”, “control unit” or “data evaluation means”, as used here, encompasses processing means in the broadest sense, that is to say for example servers, universal processors, graphics processors, digital signal processors, application-specific integrated circuits (ASICs), programmable logic circuits such as FPGAs, discrete analog or digital circuits and any desired combinations thereof, including all other processing means that are known to the person skilled in the art or will be developed in the future. In this case, processors can consist of one or more apparatuses or devices or units. If a processor consists of a plurality of apparatuses, the latter can be designed or configured for parallel or sequential processing or execution of instructions.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A system for the cryptographically protected monitoring of at least one component of a device or an apparatus comprising:
a device for providing at least one second link of a blockchain, the at least one second link comprising at least one transaction data set comprising a monitored operating state of at least one component of the device or the apparatus,
device for linking the at least one second link to a first link of the same or a further blockchain,
device for providing a checking function which checks a transaction to be carried out, which transaction is defined by the at least one transaction data set, for integrity, and
device for forming a transaction data set having a measure assigned to the operating state, depending on the checking result yielded by the checking function, wherein the transaction defined by the transaction data set is able to be carried out by a component of the device or of the apparatus and the measure is at least one of able to be initiated and able to be carried out by the same or a different component or by a station situated outside the device or the apparatus.

2. The system as claimed in the claim 1, wherein the first link comprises a further monitored operating state of at least one further component of the device or of the apparatus.

3. The system as claimed in claim 1, wherein a negative checking result comprises a value for an error and/or for a manipulation or for an absence of an expected transaction data set.

4. The system as claimed in claim 1, wherein a positive checking result comprises a value for a confirmation.

5. The system as claimed in claim 1, wherein the monitoring of the at least one and/or further component is implemented by a so-called smart contract.

6. The system as claimed in claim 1, wherein the operating state relates to a device- or apparatus-internal state.

7. The system as claimed in claim 1, wherein the operating state relates to at least one of a state of sensors, actuators and control units for the device or the apparatus which are arranged outside the device or the apparatus.

8. A method for the cryptographically protected monitoring of at least one component of a device or an apparatus comprising the following steps:
providing at least one second link of blockchain, the at least one second link comprising at least one transaction data set, wherein a monitored operating state of at least one component of the device or of the apparatus is represented in the transaction data set,
linking the at least one second link to a first link of the same or a further blockchain,
providing a checking function which checks the transaction data set for integrity/admissibility, and
forming a transaction data set having a measure assigned to the operating state, depending on the checking result yielded by the checking function, wherein the transaction defined by the transaction data set is carried out by a component of the device or of the apparatus and the measure is initiated and/or is carried out by the same or a different component or by a station situated outside the device or the apparatus.

9. The method as claimed claim 8, wherein the first link comprises a further monitored operating state of at least one further component of the device or of the apparatus.

10. The method as claimed in claim 8, wherein a negative checking result comprises at least one of a value for an error and for a manipulation or for an absence of an expected transaction data set.

11. The method as claimed in claim 9, wherein at a positive checking result comprises a value for a confirmation.

12. The method as claimed in claim 1, wherein the monitoring of the operating state of the at least one and/or further component is implemented by a so-called smart contract.

13. The method as claimed in claim 1, wherein the operating state relates to a device- or apparatus-internal state.

14. The method as claimed in claim 1, wherein the operating state relates to a state of sensors, actuators and/or control units for the device or the apparatus which are arranged outside the device or the apparatus.

15. A computer program product having program instructions for the system as claimed in claim 1, comprising a computer readable hardware storage device having computer readable program code stored therein, said program code executable by a processor of a computer system to implement a method, which is configured by the program instructions which are suitable for the cryptographically protected monitoring of at least one component of the system and form at least one link of a blockchain, the transaction data set of said at least one link comprising a monitored operating state of at least one component of the device or of the apparatus.

16. A system for the cryptographically protected monitoring of at least one component of a device or an apparatus comprising:
means for providing at least one second link of a blockchain, the at least one second link comprising at least one transaction data set comprising a monitored operating state of at least one component of the device or the apparatus,
means for linking the at least one second link to a first link of the same or a further blockchain,
means tor providing a checking function which checks a transaction to be carried out, which transaction is defined by the at least one transaction data set, for integrity, and
means for forming a transaction data set having a measure assigned to the operating state, depending on the checking result yielded by the checking function, wherein the transaction defined by the transaction data set is able to be carried out by a component of the device or of the apparatus and the measure is able to be initiated and/or able to be carried out by the same or a different component or by a station situated outside the device or the apparatus.
